(19) United States
(12) Patent Application Publication
(10) Pub. No.: US 2022/0111911 A1
(43) Pub. Date: Apr. 14, 2022

(54) CHASSIS COMPONENT WITH AT LEAST ONE CONNECTING SECTION FOR CONNECTING TO A MOUNTING SECTION OF A CHASSIS ELEMENT

(71) Applicant: ZF Friedrichshafen AG, Friedrichshafen (DE)

(72) Inventors: Tobias LAHRMANN, Osnabrück (DE); Ernst Willi Sven KUHLMANN, Lemförde (DE); Artur BERGER, Bohmte (DE)

(21) Appl. No.: 17/495,032

(22) Filed: Oct. 6, 2021

(30) Foreign Application Priority Data
Oct. 9, 2020 (DE) 10 2020 212 778.6

(51) Int. Cl. B62D 27/02

(52) U.S. Cl. CPC B62D 27/02

(57) ABSTRACT

A chassis component (1, 18, 21, 22) with at least one connecting feature (8, 9) for connecting to a mounting section (2) of a chassis element (3) and including at least one positioning and force introduction device (10, 11) for automatic positioning of the mounting section (2) for the mounting of the chassis element (3) on the chassis component (1, 18, 21, 22). To reduce the complexity and/or the costs for producing the chassis component (1, 18, 21, 22), the positioning and force introduction device (10, 11) of the component is formed as an integral part of the chassis component (1, 18, 21, 22).

This application claims priority from German patent application serial No. 10 2020 212 778.6 filed Oct. 9, 2020.

### FIELD OF THE INVENTION

The invention relates to a chassis component with at least one connecting section for connecting to a mounting section of a chassis element, and with at least one positioning and force introduction device for the automatic positioning of the mounting section for the mounting of the chassis element on the chassis component.

### BACKGROUND OF THE INVENTION

A chassis component of this type is known to the applicant and is shown in FIG. 1 as the prior art. In this case the positioning and force introduction device is in the form of an independent component designed as a V-shaped sheet, which is fastened to the chassis component. This fastening of the V-shaped sheet to the chassis component can be realized for example by pressure-connection, also called clinching. Specifically, the chassis component has two such positioning and force-application devices in the form of V-shaped sheets, which are arranged opposite one another and mirror-symmetrically.

In this it is disadvantageous that the production of the V-shaped sheet as a separate component and the necessary joining step for connecting the separate component to the chassis component result in undesired complexity and costs in the production of the chassis component.

### SUMMARY OF THE INVENTION

The purpose of the present invention is to develop further a chassis component of the type mentioned to begin with, in such manner that the complexity and/or costs for the production of the chassis component can be reduced. In particular, an alternative embodiment should be provided.

The objective upon which the invention is based is achieved by a chassis component according to the independent claim(s). Preferred further developments of the invention emerge from the subordinate claims and from the description that follows.

The chassis component comprises at least one connecting feature for connection to a mounting section of a chassis element. In particular, the mounting section of the chassis element is arranged or formed on a free end of the chassis element. The mounting section of the chassis element can co-operate with the connecting feature of the chassis component for fastening the chassis element to the chassis component. Preferably, the chassis element is in the form of a spring device, a suspension strut, a shock-absorber or an air spring. Furthermore, the chassis component comprises at least one positioning and force introduction device for the automatic positioning of the mounting section for the mounting of the chassis element on the chassis component. In particular, the connecting feature and the positioning and force introduction device are formed as independent parts and/or sections of the chassis component. Preferably, during the mounting of the chassis element on the chassis component, by virtue of the positioning and force introduction device the mounting section is positioned automatically in such manner that the mounting section of the chassis can be connected simply or with no further position correction to the connecting feature of the chassis component. In particular, the mounting section is positioned automatically by inserting the mounting section of the chassis element into the positioning and force introduction device. Preferably, during the mounting of the chassis element on the chassis component the mounting section is guided in such manner that in the final position of the mounting section in the positioning and force introduction device, the mounting section and the connecting feature are correctly orientated for producing a joint with one another. Preferably, during the intended use of the chassis component in a chassis of a vehicle, forces are transmitted to the chassis component by way of the chassis element and the positioning and force introduction device. The positioning and force introduction device is formed as an integral part of the chassis component.

Here, it is advantageous that a separate component for forming the positioning and force introduction device can be dispensed with. Furthermore, there is no need for an extra working step for connecting the separate component to the chassis component, as there is when the positioning and force introduction device is made as a separate component. By virtue of the design of the positioning and force introduction device as an integral part of the chassis component, the complexity and thus also the costs for producing the chassis component can be reduced.

Preferably, the positioning and force introduction device is formed by cutting into the material and/or by means of a deformation of an in particular cut section of the chassis component. Thus, the positioning and force introduction device is formed and/or produced by the material of a section of the chassis component. In particular, the material of the section of the chassis component is deformed in order to produce the positioning and force introduction device. Before the deformation of the material of the section of the chassis component, a cut can be made into the material. Owing to the cut in the material, the subsequent deformation in order to form the positioning and force introduction device can be facilitated. The cut in the material can be curved or shaped as part of a circle.

According to a further embodiment, the positioning and force introduction device forms a projection for the positioning of the mounting section. In particular the positioning and force introduction device and/or the projection has a contact area for positioning the mounting section and/or forms such a contact area. Preferably, in a final position for producing a connection between the mounting section and the connecting feature of the chassis component, the mounting section rests on and/or over the contact area.

In a further development, the positioning and force introduction device is formed by stamping and/or compression molding, preferably of the material of a section of the chassis component. The stamping and/or compression molding can be V-shaped, C-shaped or U-shaped. A positioning and force introduction device formed in such manner enables the automatic positioning of the mounting section for mounting the chassis element on the chassis component. Here, the mounting section of the chassis element automatically moves to a final position in which the mounting section can be joined to the connecting feature of the chassis component without any further positional correction.

According to a further embodiment, the positioning and force introduction device is formed by a shaped strip, preferably a sheet-metal strip. Preferably the strip is formed from a section of the chassis component. In particular, the shaped strip has a U-shaped cross-section. A free end of the shaped strip can then form a contact face for positioning the mounting section.

Preferably, the positioning and force introduction device has a curved and/or circular-segment shaped contact area for the positioning and/or the interlocked retention of a cylindrical element and/or a cylindrical outer surface of the mounting section. In that case the cylindrical element can be in the form of a cylindrical outer surface of the inner portion of a joint of the mounting section. The co-operation of the curved or circular-segment shaped contact face with the cylindrical element of the mounting section enables the automatic positioning of the mounting section during the mounting of the chassis element on the chassis component.

According to a further development, the connecting feature of the chassis component is in the form of a through-going opening for passing through a separate fastening means and for connection to the mounting section of the chassis element. The through-going opening can be a hole or a bore. The separate fastening means can be a screw or a bolt.

Preferably, the chassis component has a U-shaped cross-section. In this case two connecting features and two positioning and force introduction devices are formed on two sidewalls a distance apart from one another. In particular, the two sidewalls extend parallel to one another and/or mirror-symmetrically to one another away from a base surface of the chassis component. The base surface connects the two sidewalls to one another. In particular, the chassis component is in the form of a sheet-metal tension strut. Thus, the chassis component can be made inexpensively by deforming a sheet material. The U-shaped cross-section of the chassis component is produced in that way. In particular, a first sidewall comprises a first connecting feature and a first positioning and force introduction device. A second sidewall comprises a second connecting feature and a second positioning and force introduction device. In the area of the mounting section of the chassis element and/or close to the positioning and force introduction devices, the base surface has a material perforation. The material perforation creates an opening in or through which the chassis element and/or the mounting section of the chassis element can extend, at least partially.

Preferably, the two positioning and force introduction devices are made mirror-symmetrically to one another. The positioning and force introduction devices can extend one over the other toward and/or into an inside space of the U-shaped cross-section of the chassis component, preferably between the two sidewalls. Particularly advantageous is a chassis component according to the invention with a chassis element, wherein the mounting section of the chassis element is arranged between a first connecting feature and a second connecting feature of the chassis component. In this case a separate fastening means extends through the two connecting features and through an inner portion of the joint of the mounting section of the chassis element. In addition, in this case the inner joint portion is partially supported on a first positioning and force introduction device and on a second positioning and force introduction device.

### BRIEF DESCRIPTION OF THE DRAWINGS

Below, the invention is explained in greater detail with reference to the figures. In these, the same indexes denote the same, similar or functionally equivalent components or elements. The figures show:

FIG. 1: A detail of a chassis component according to the prior art,

FIG. 2: A perspective view of a detail of a sectioned first chassis component according to the invention,

FIG. 3: A sectioned front view of the first chassis component according to the invention, shown in FIG. 2,

FIG. 4: A detail of a sectioned side view of the first chassis component according to the invention, shown in FIGS. 2 and 3,

FIG. 5: A sectioned front view of a second chassis component according to the invention,

FIG. 6: A detail of a sectioned perspective side view of the second chassis component according to the invention, shown in FIG. 5,

FIG. 7: A sectioned front view of a third chassis component according to the invention,

FIG. 8: A detail of a sectioned perspective side view of the third chassis component according to the invention, shown in FIG. 7,

FIG. 9: A sectioned front view of a further chassis component according to the invention, and

FIG. 10: A detail of a sectioned perspective side view of the further chassis component according to the invention.

### DETAILED DESCRIPTION OF THE PREFERRED EMBODIMENTS

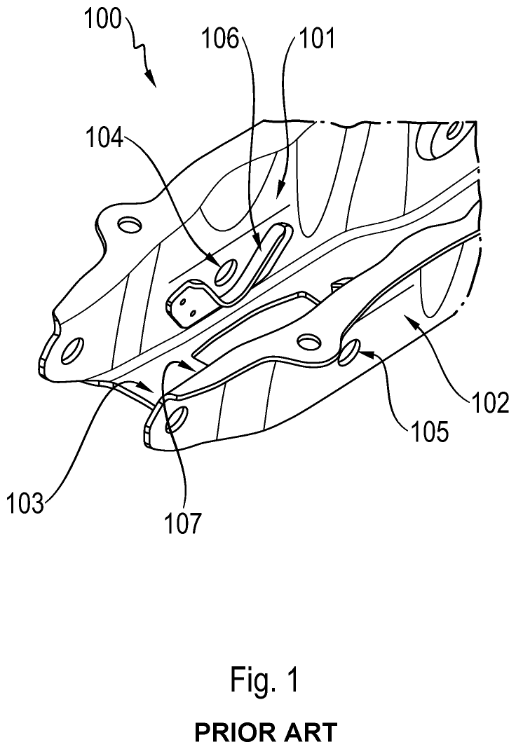

FIG. 1 shows a detail of a perspective view of a chassis component 100 according to the prior art. In this example embodiment the chassis component 100 is a control arm made from sheet metal. The chassis component 100 has an essentially U-shaped cross-section. Accordingly, the chassis component 100 has two sidewalls 101 and 102 a distance apart from one another. Between the sidewalls 101, 102 is arranged a base surface 103, away from which the sidewalls 101, 102 extend.

In the area of the first sidewall 101, the chassis component 100 has a first connecting feature 104 and opposite it, in the area of the second sidewall 102, there is a second connecting feature 105 for connecting with a mounting section (not shown here) of a chassis element. Such a chassis element can for example be in the form of a suspension strut. The two connecting features 104, 105 are in this case each in the form of through-going openings.

Furthermore, on the first sidewall 101 the chassis component 100 has a first positioning and force introduction device 106. A correspondingly formed second positioning and force introduction device 107 is arranged on the second sidewall 102 but cannot be seen here. The positioning and force introduction device 106 or 107 is in each case formed as an independent and separate component, which in this example embodiment is connected to the sidewalls 101 or 102 by clinching.

Thus, to form the positioning and force introduction device 106 or 107 a separate component must first be made and connected to the sidewall 101 or 102 in an independent working step. This results in undesired additional effort and undesired added cost.

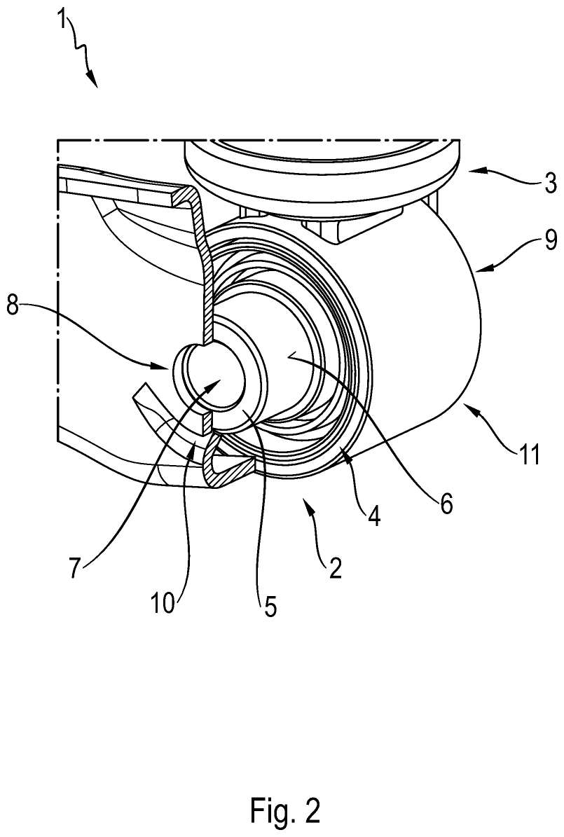

FIG. 2 shows in perspective a detail of a partially sectioned first chassis component 1 according to the present invention. In this example embodiment the chassis component 1 is in the form of a sheet-metal control arm. The chassis component 1 is designed to be connected to a mounting section 2 of a chassis element 3. The mounting section 2 is arranged in the area of a free end of the chassis element 3. In this case the chassis element 3 is in the form of a suspension strut.

In this example embodiment the mounting section 2 consists of a joint 4. Accordingly, the mounting section 2 or joint 4 has an inner joint portion 5. The inner joint portion 5 extends out of the joint 4 on two sides remote from one another. Furthermore, at least in the area that extends out of the joint 4, the inner joint portion 5 has a cylindrical outer surface 6. The inner joint portion 5 has a through-going passage 7 which, in this example embodiment, is of hollow-cylindrical form.

The mounting section 2 or chassis element 3 is shown here in an end position relative to the chassis component 1 and is arranged for mounting of the chassis element 3 on the chassis component 1. In the said end position the through-going passage 7 is aligned with a first connecting feature 8 and a second connecting feature 9 (not visible here) of the chassis component 1. In this case the two connecting features 8 and 9 are opposite one another.

In addition, the chassis component 1 has a first positioning and force introduction device 10 and a second positioning and force introduction device 11 (not visible here). The structure and functional mode of the two positioning and force introduction devices 10, 11 are described in greater detail in the figures that follow.

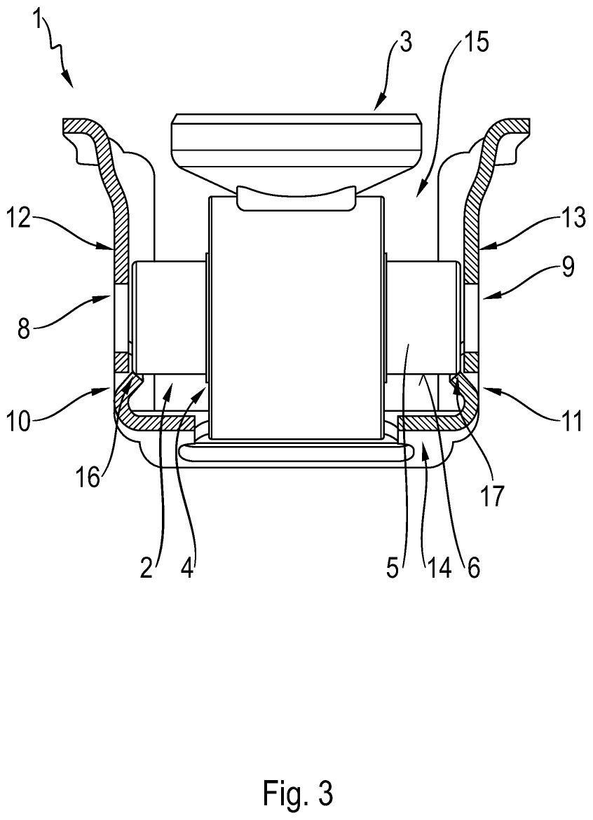

FIG. 3 shows a sectioned front view of the first chassis component 1 according to the invention as it is illustrated in FIG. 2. The chassis component 1 has an essentially U-shaped or U-like cross-section. The chassis component 1 has two sidewalls 12, 13 a distance apart from one another, and are connected to one another by means of a base surface 14 arranged between the two sidewalls 12, 13. The two sidewalls 12, 13 extend parallel to one another and essentially perpendicularly away from the base surface 14.

The two positioning and force introduction devices 10, 11 serve for the automatic positioning of the mounting section 2 for the mounting of the chassis element 3 on the chassis component 1. In addition, during the intended use of the chassis component 1 in a chassis of a vehicle the positioning and force introduction devices 10, 11 serve to transmit forces introduced into the chassis component 1 by way of the chassis element 3 and the positioning and force introduction devices 10, 11. In this case the positioning and force introduction devices 10, 11 are each in the form of an integral part or section of the chassis component 1.

In this example embodiment the positioning and force introduction devices 10, 11 are each formed by means of a cut in the material and by means of a deformation of an cut section of the chassis component 1. The positioning and force introduction devices 10, 11 are formed mirror-symmetrically relative to one another and shaped toward one another and into an inside space 15 of the chassis component 1. In that way the positioning and force introduction devices 10, 11 each form a projection for positioning the mounting section 2.

The positioning and force introduction device 10 or 11 each has a curved or circular-section shaped contact area 16 or 17, respectively. The cylindrical outer surface 6 of the inner joint portion 5 rests on the said contact areas 16 and 17. This determines the final position of the mounting section 2 or chassis element 3 when mounting it on the chassis component 1. In this final position the through-going passage 7 and the two connecting features 8, 9 are aligned with one another, so that a separate fastening means (not shown here) can be passed through the two connecting features 8, 9 and through the through-going passage 7 in order to mount the mounting section 2 onto the chassis component 1.

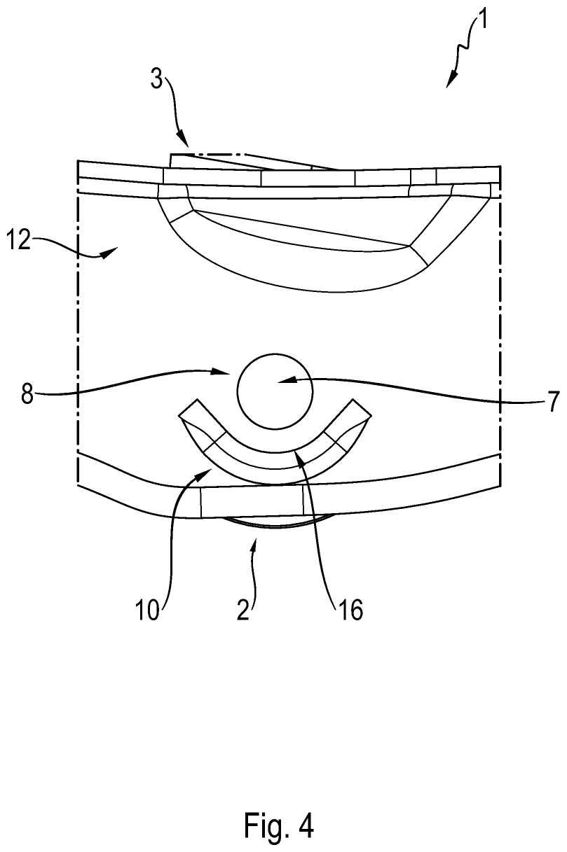

FIG. 4 shows a detail of a sectioned side view of the first chassis component 1 according to the invention, as illustrated in FIGS. 2 and 3. The aligned arrangement of the first connecting feature 8 with the through-going passage 7 can be seen clearly. Moreover, the circular-section shaped structure of the contact area 16 can be seen.

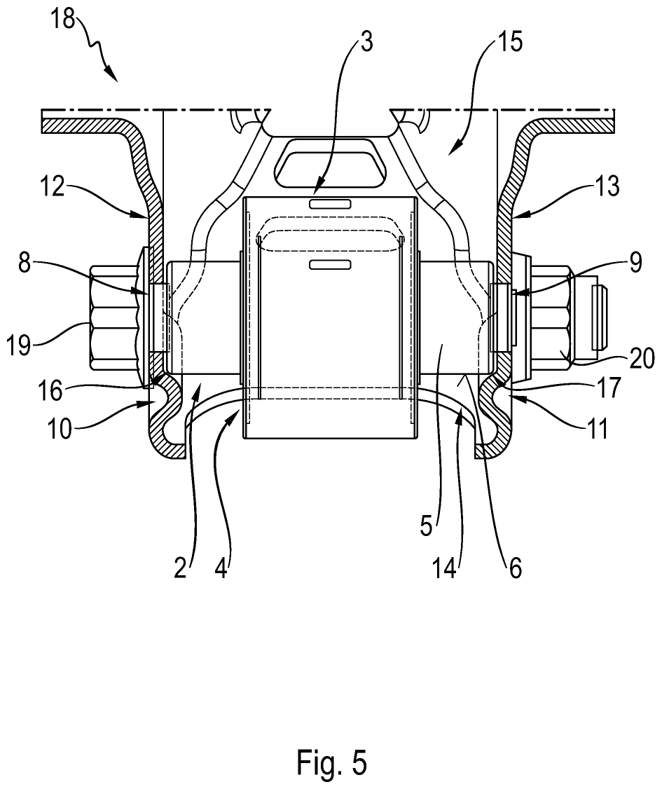

FIG. 5 shows a sectioned front view of a second chassis component 18 according to the invention. The same features are given the same indexes as before. Accordingly, reference should be made to the previous description.

In this example embodiment an additional fastening means 19 is shown, which extends through the two connecting features 8, 9 and the through-going passage 7 of the inner joint portion 5 in order to connect the mounting section 2 to the chassis component 18. The fastening means 19 in this example embodiment is in the form of a bolt secured by a separate nut 20. Such a fastening means can also be use with a chassis component according to FIGS. 2 to 4.

In contrast to the embodiment according to FIGS. 2 to 4, in this example embodiment the positioning and force introduction devices 10, 11 are formed exclusively by deforming in each case a section of the chassis component 18. Here, there is no need to cut through the material. Thus, the positioning and force introduction devices 10, 11 are each in the form of embossed areas of the material of the respectively deformed section of the chassis component 18.

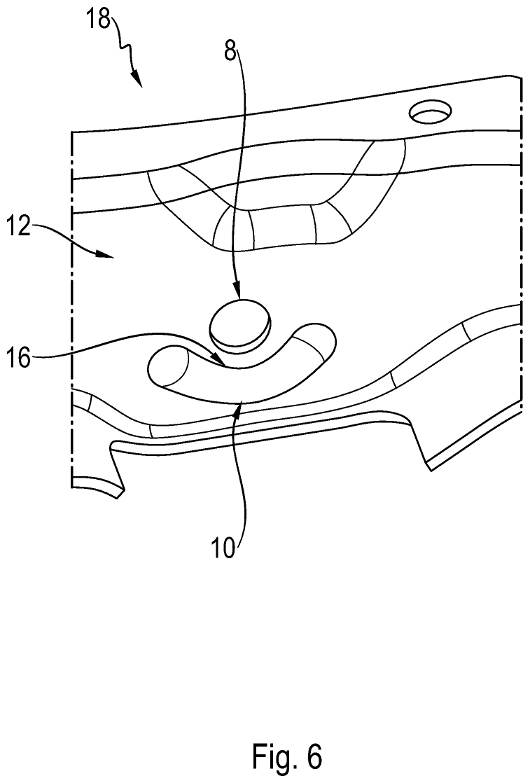

FIG. 6 shows a detail of a sectioned perspective side view of the second chassis component 18 according to the invention, as in FIG. 5 but without the mounting section 2. Here, it can be seen clearly that the positioning and force introduction device 10 and, corresponding thereto, the positioning and force introduction device 11 (which cannot be seen in this case) are each formed as an essentially V-shaped embossment in the material of the sidewalls 12 and 13 respectively.

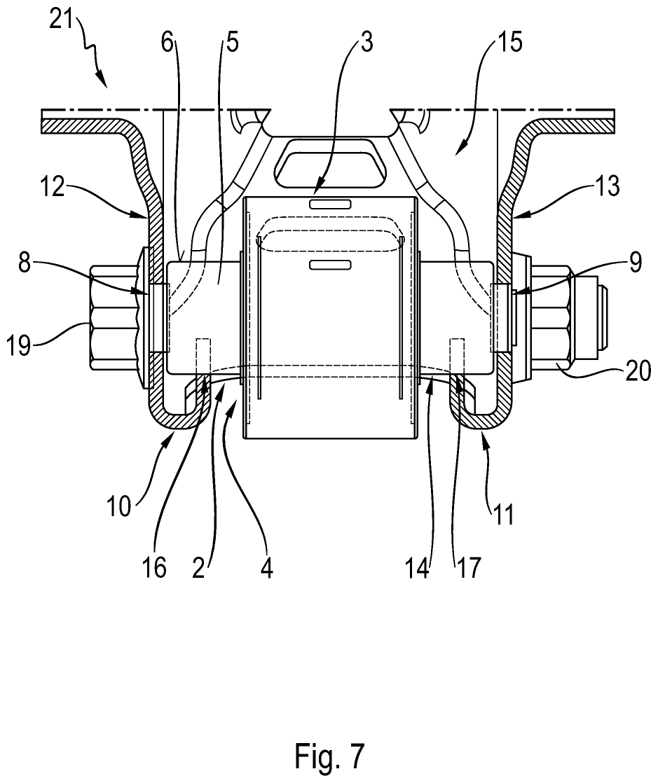

FIG. 7 shows a sectioned front view of a third chassis component 21. The same features are again given the same indexes as before, and accordingly reference should be made to the previous description.

In this example embodiment the positioning and force introduction devices 10, 11 are each formed by a deformed strip. In other words, the positioning and force introduction devices 10 and 11 are produced by deforming a section of the chassis component 21, namely a section of the sidewalls 12 and 13. The positioning and force introduction devices 10, 11 or the respective deformed strips are U-shaped in cross-section. Free end faces of the positioning and force introduction devices 10, 11, or of the correspondingly deformed strips, form the positioning and force introduction devices 10, 11 or the respective contact areas 16 and 17 for positioning the mounting section 2.

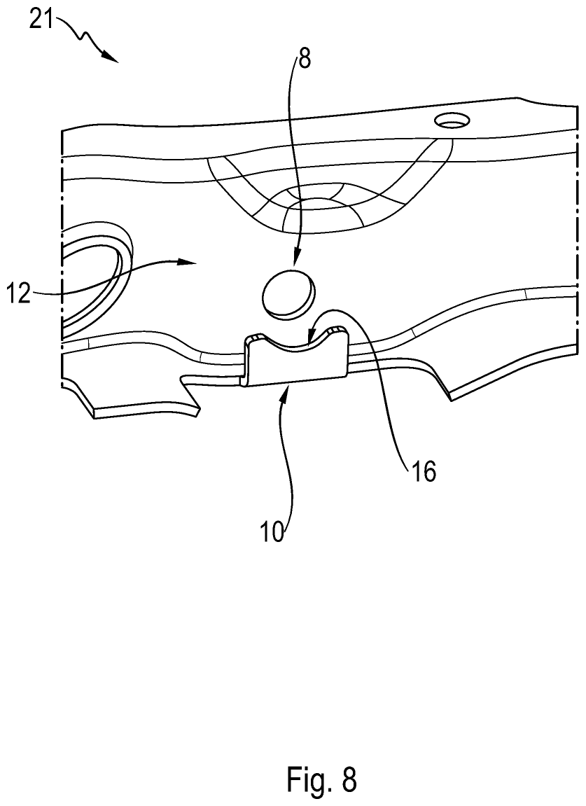

FIG. 8 shows a detail of a sectioned perspective side view of the third chassis component 21 according to the invention illustrated in FIG. 7, without the mounting section 2. Clearly to be seen is the circular-section shaped contact area 16 for the interlocked holding of the cylindrical outer surface 6 of the inner joint portion 5 shown in FIG. 7.

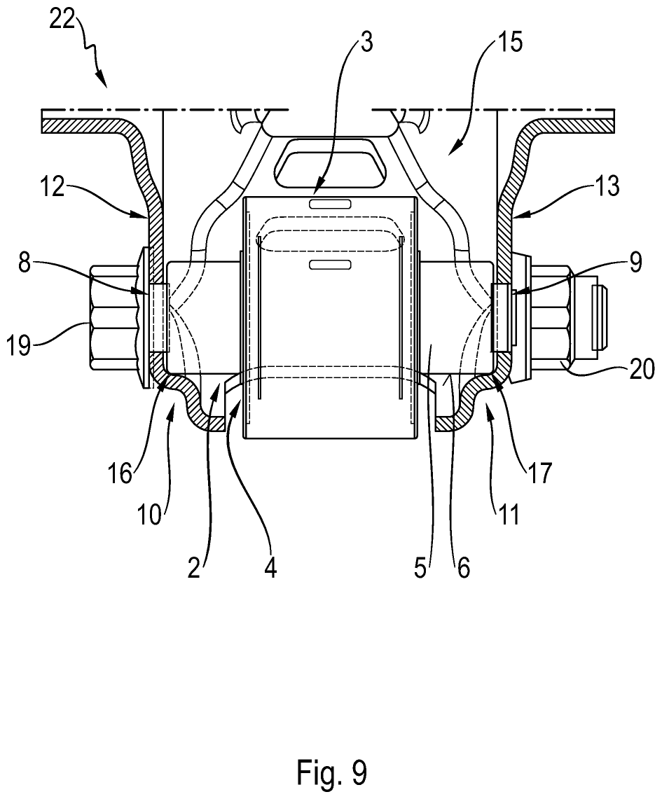

FIG. 9 shows a sectioned front view of a further chassis component 22 according to the invention. The same features are again given the same indexes as before, and accordingly reference should be made to the previous description.

In this example embodiment the positioning and force introduction devices 10, 11 are in the form of an embossed area in the material of a section of the chassis component, namely a section of the sidewalls 12 and 13 respectively.

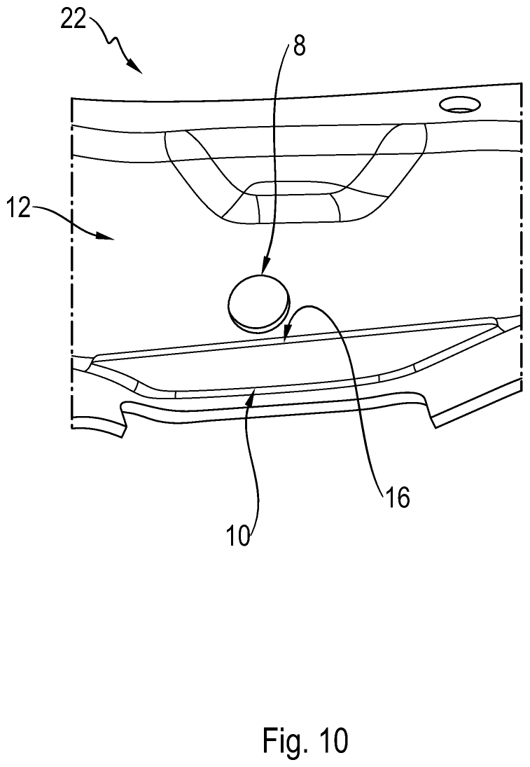

FIG. 10 shows a detail of a sectioned perspective side view of the said further chassis component 22 according to the invention, without the mounting section 2. It can be seen clearly that the contact area 16 of the positioning and force introduction device 10 and, correspondingly, the contact area 17 (not visible) of the positioning and force introduction device 11 is straight, otherwise than in the previous example embodiments.

### INDEXES

1 Chassis component

2 Mounting section

3 Chassis element

4 Joint

5 Inner joint portion

6 Cylindrical outer surface

7 Through-going passage

8 First connecting feature

9 Second connecting feature

10 First positioning and force introduction device

11 Second positioning and force introduction device

12 First sidewall

13 Second sidewall

14 Base surface

15 Inside space

16 Contact area

17 Contact area

18 Chassis component

19 Fastening means

20 Nut

21 Chassis component

22 Chassis component

100 Chassis component

101 Sidewall

102 Sidewall

103 Base surface

104 First connecting feature

105 Second connecting feature

106 First positioning and force introduction device

107 Second positioning and force introduction device

1-10. (canceled)

11. A chassis component comprising:
at least one connecting feature (8, 9) for connecting to a mounting section (2) of a chassis element (3),
at least one positioning and force introduction device (10, 11) for automatic positioning of the mounting section (2) for mounting the chassis element (3) on the chassis component (1, 18, 21, 22), and
the positioning and force introduction device (10, 11) being in a form of an integral part of the chassis component (1, 18, 21, 22).

12. The chassis component according to claim 11, wherein the positioning and force introduction device (10, 11) is formed by at least one of a cut in a material of the chassis component and a deformation of a cut section of the chassis component (1, 18, 21, 22).

13. The chassis component according to claim 11, wherein the positioning and force introduction device (10, 11) forms a projection for positioning the mounting section (2), and the projection has a contact area (16, 17) for positioning the mounting section (2).

14. The chassis component according to claim 11, wherein the positioning and force introduction device (10, 11) is formed by one of a V-shaped, a C-shaped ora U-shaped embossment and/or pressed molding in a material of a section of the chassis component (1, 18, 21, 22).

15. The chassis component according to claim 11, wherein the positioning and force introduction device (10, 11) is formed by a deformed sheet-metal strip, and the sheet-metal strip has at least one of a U-shaped cross-section and a contact area (16, 17) formed by a free end face of the sheet-metal strip for positioning the mounting section (2).

16. The chassis component according to claim 11, wherein the positioning and force introduction device (10, 11) has a curved or circular-section shaped contact area (16, 17) for positioning and/or for interlocked holding of a cylindrical element and/or a cylindrical outer surface (6) of the mounting section (2).

17. The chassis component according to claim 11, wherein the connecting feature (8, 9) is in a form of a through-going opening for passing a separate fastening means (19) through and for connecting to the mounting section (2) of the chassis element (3).

18. The chassis component according to claim 11, further comprising U-shaped cross-section, wherein two connecting feature (8, 9) and two positioning and force introduction devices (10, 11) are formed on two sidewalls (12, 13) and spaced apart from one another, and the chassis component (1, 18, 21, 22) is in the form of a sheet-metal control arm.

19. The chassis component according to claim 18, wherein the two positioning and force introduction devices (10, 11) at least one of:
are formed mirror-symmetrically to one another, or
extend over one another at least one of toward and into an inside space (15) of the chassis component (1, 18, 21, 22).

20. The chassis component according to claim 11, having the chassis element (3), the mounting section (2) of the chassis element (3) is arranged between a first connecting feature (8) and a second connecting feature (9) of the chassis component (1, 18, 21, 22), a separate fastening means (19) extends through the first and second connecting features (8, 9) and through an inner joint portion (5) of the mounting section (2) of the chassis element (3), and the inner joint portion (5) is partially supported on a first positioning and force introduction device (10) and on a second positioning and force introduction device (11).
